(19) United States
(12) Patent Application Publication
(10) Pub. No.: US 2015/0364739 A1
(43) Pub. Date: Dec. 17, 2015

(54) FLEXIBLE POROUS ALUMINUM OXIDE FILMS

(71) Applicant: THE REGENTS OF THE UNIVERSITY OF CALIFORNIA, Oakland, CA (US)

(72) Inventors: Angelica M. STACY, Oakland, CA (US); Christopher E. SNEDIGAR, Hayward, CA (US)

(21) Appl. No.: 14/739,903

(22) Filed: Jun. 15, 2015

Related U.S. Application Data
(60) Provisional application No. 62/012,121, filed on Jun. 13, 2014.

(51) Int. Cl. H01M 2/16; H01M 2/18; H01M 10/0525; C01F 7/02

(52) U.S. Cl. CPC H01M 2/1646; C01F 7/02; H01M 2/18; H01M 10/0525; C01P 2006/40; C01P 2006/16; H01M 2220/20; H01M 2220/30

(57) ABSTRACT

The present invention provides flexible, porous aluminum oxide and methods for its synthesis. The films exhibit surprising mechanical properties when compared to standard porous aluminum oxide. The flexible, porous aluminum oxide is of use as a separator in lithium-ion batteries. The flexibility of the films improves the capabilities and efficiencies of lithium-ion batteries.

### CROSS REFERENCE TO RELATED APPLICATIONS

The present application claims priority under 35 U.S.C. §119(e) to U.S. Provisional Patent Application No. 62/012,121 filed Jun. 13, 2014, which is incorporated herein by reference in its entirety.

### BACKGROUND OF THE INVENTION

Lithium batteries are the preferred energy source in various applications due to their energy density, power, and shelf life characteristics. Examples of lithium batteries include non-aqueous batteries such as lithium-ion and lithium polymer batteries.

A separator between positive and negative electrodes of a conventional lithium battery constitutes an important component of the battery. Separators for conventional, planar lithium-ion batteries are typically solid micro-porous polyolefin films that are assembled in a sheet form and rolled in the form of a cathode/separator/anode/separator stack. This stack is rolled tightly and inserted into a can, filled with electrolyte, and then sealed. For example, reference to P. Arora and Z. Zhang, “Battery separators,” Chem. Rev., 2004, 104, 4419-4462, may help to illustrate the state of the art in battery separators, and is therefore incorporated by reference as non-essential subject matter herein.

Three-dimensional battery architectures (e.g., interdigitated electrode arrays) have been proposed in the literature to provide higher electrode surface area, higher energy and power density, improved battery capacity, and improved active material utilization compared with two-dimensional architectures (e.g., flat and spiral laminates). For example, reference to Long et al., “Three-dimensional battery architectures,” Chemical Reviews, 2004, 104, 4463-4492, may help to illustrate the state of the art in proposed three-dimensional battery architectures, and is therefore incorporated by reference as non-essential subject matter herein. FIG. 9 shows a schematic representation of a cross-section of one example of a three-dimensional battery that has been proposed in the literature. The battery includes a cathode current collector 10 from which cathodes 11 extend into a height direction at various points. A similar structure is made with an anode current collector 14 and anodes 13. The regions between the cathodes 11 and the anodes 13 (and some areas of the current collectors 10 and 14) include electrolyte 12.

The cathodes 11 and anodes 13 may be assembled in various three-dimensional configurations. This can include, for example, inter-digitated pillars or plates where the anodes 13 and the cathodes 11 are in proximity to each other in more than one direction. For example, in FIG. 9, each anode 13 is in close proximity to two cathodes 11, one on either side. In structures such as pillars, each electrode could be in proximity to surfaces from more than 2 counter electrodes. The anode and cathode current collectors 10 and 14 can be separate (top and bottom connection as shown in FIG. 9) or co-planar.

Improved separators for use in lithium batteries are needed in the art. The present invention provides such improved separators.

### BRIEF SUMMARY OF THE INVENTION

The inherent brittleness of ceramic materials, including porous aluminum oxide (PAO), is a source of concern for its utilization in various applications, including as a separator in a lithium-ion battery. During assembly of a battery, significant torsion of materials is common. These manipulations can easily cause the material to crack and break—rendering the film inoperable as a separator.

The present invention addresses the issue of PAO film flexibility, providing flexible, porous aluminum oxide films and methods of making such films. The inventors have discovered that the method of releasing the oxide affects the mechanical properties of the final film. In various embodiments, the invention provides a flexible film that is produced using a method other than amalgamation to remove the film from the aluminum substrate on which it is formed by a method. Accordingly, in an exemplary embodiment, the invention utilizes a new method of releasing PAO from the aluminum substrate based on a reverse current application. The new release method has a significant impact on the macroscale mechanical properties of PAO, imparting improved flexibility to the PAO film. The PAOs of the invention show enhanced resistance to tensile strain, as demonstrated by bending measurements.

In an exemplary embodiment, the invention provides a flexible PAO film that can reach an Fracture Strain of 1.2×10⁻². Exemplary films of the invention have a radius of curvature of at least about 0.6 mm.

Also provided are methods of making the films of the invention. An exemplary method comprises removing the film from the substrate on which it is formed by reversing the current on the substrate.

In various embodiments, the invention provides a lithium battery in which a PAO film of the invention is incorporated as a separator.

Other objects, advantages and embodiments of the invention will be apparent from the detailed description that follows.

### BRIEF DESCRIPTION OF THE DRAWINGS

FIG. 1. Optical images of an 18 mm aluminum foil electrode with a 25 μm layer of PAO on the surface in 4 different stages of PAO removal. From top left to right: Image 1—displays the metallic, reflective aluminum underneath the clear PAO film. Image 2—displays the aluminum electrode directly after a current is applied. The reflective appearance is muted due to the formation of many bubbles rising to the surface in from of the electrode. Many bubbles form around the perimeter. Image 3-5 minutes after a current is applied. A large gas bubble has formed between the PAO and the aluminum electrode. This is observed by a darkening of the region (highlighted by the blue line). In real time, the bubble can be seen to be pulsing and moving between the layers. Image 4-47 minutes after current is applied. A uniform white appearance has replaced the reflective one that the aluminum began with. All pinning areas are removed.

FIG. 2. SEM images of PAO subjected to amalgamation (left images) and reverse current (right images). The top images show the top side of PAO, with open pores. The bottom images show the bottom side of PAO, the pores here are capped with a layer of PAO. The images show there is no differentiation between the two films.

FIG. 3. A cartoon depicting a bent film and the radius of curvature. When the rectangular film (with thickness t) is bent, the material above ½ is under tensile stress (σₜ) and the material below ½ is under compressive stress (σ_{c}). A circle can be superimposed over the bent film, such that the circle directly overlays the mid-thickness point. The radius of this circle is the radius of curvature. The bending angle (θ) is the angle between the edges of the bent film.

FIG. 4. An image of flexible-PAO bending. The PAO was colored black with a permanent marker for contrast. A blue circle was superimposed on the image and shows that this sample has a radius of curvature of 1.12 mm.

FIG. 5. FTIR spectrum of PAO made in an oxalic acid solution after an annealing step. The peaks at 2337, 1539 and 1471 cm⁻¹ are due to the oxalate ions (Mata-Zamora, et al., Revista Mexicana de Fisica, 2009, 51:502-509; Fujita, et al., The Journal of Physical Chemistry, 1957, 61:1014-1015). Note there is no water present, indicated by no signal around 3500 cm⁻¹.

FIG. 6. A cartoon depicting the organization of a typical CR2032 cell used in this work.

FIG. 7. Graphs showing the decay of the charge capacity versus cycle number of representative samples from each generation of coin cell made with PAO against the Celgard 2500 control. The SEI layer formation was considered complete once the charge capacity reached its maximum. Note that the generation 1 and 2 coin cells reach a maximum capacity and decay in capacity very quickly—reaching a ‘dead state’ early on. This is due to the presence of water in the PAO separators. The generation 3 coin cell displays a maximum charge capacity decay similar to the Celgard 2500, which confirms the capability of PAO to be a replacement separator for polypropylene in Li-ion batteries. Both of these cells are still cycling 5 months after the experiment was started and have not yet reached 80% of their initial capacity.

FIG. 8. Cartoon depiction of a capped PAO separator in a lithium-ion battery while discharging. Lithium ions migrate, via the electrolyte, from the negative electrode (usually graphite) through the separator to the positive electrode (a heavy metal oxide). Electrons meanwhile take the path from the negative electrode to the positive electrode via the wire and load. The directions the lithium ions and electrons migrate is reversed when the cell is being charged.

FIG. 9 is a schematic illustration of a cross-section of one example of a three-dimensional lithium-ion battery that has been proposed in the literature.

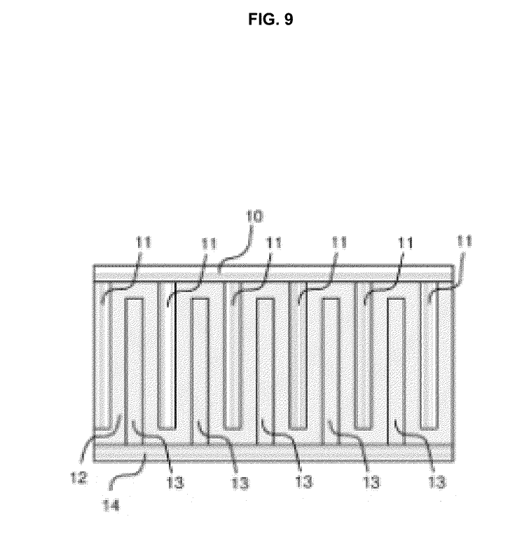

FIG. 10A-FIG. 10D are schematic illustrations of some three-dimensional energy storage system architectures that may be used in conjunction with certain embodiments of the present invention.

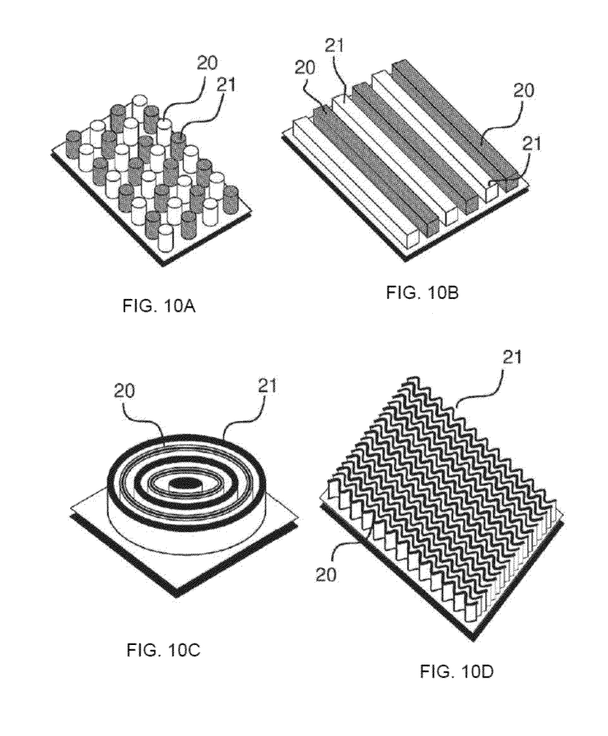

### DETAILED DESCRIPTION OF THE INVENTION

### I. Introduction

Ceramic materials are key components of many devices and structures. An exemplary use for ceramic materials is as a porous separator in batteries. Separator membranes are important components of batteries. These membranes serve to prevent contact of the anode and cathode of the battery while permitting electrolyte to pass there through. Additionally, battery performance attributes such as cycle life and power can be significantly affected by the choice of separator. Safety can also be related to separator attributes, and certain separators are known to reduce occurrence of Li metal plating at the anode and even dendrite formation.

Separator membranes of battery cells are, in some instances, formed from bodies of porous ceramic of organic polymer materials. In other instances, separator membranes are formed from bodies of fibrous or particulate material. Such materials can include glass fibers, mineral fibers such as asbestos, ceramics, synthetic polymeric fibers as well as natural polymeric fibers such as cellulose.

There are a number of problems with the presently utilized separator membranes. Such membranes materials are often expensive, and given the fact that a typical battery system will include relatively large volumes of membranes, the cost of the membranes can be a significant component of overall battery costs. Typical separator membranes used in prior art lithium ion cells are made from polymers such as polyethylene or polypropylene, and they may be fabricated in either a wet or a dry process. These processes are relatively expensive, and membranes produced thereby have costs in the range of several dollars per square meter. The high cost of the separators translates to high cost for finished cells. Any reduction in the cost of the membrane will translate to significant savings in the overall cost of batteries. In addition, polymer separators must maintain their size and shape as temperatures are increased beyond the usual operating temperatures, to assure continued physical separation between anode and cathode. Many separators shrink unacceptably at increased temperatures and unacceptably allow the two electrodes to contact each other and thereby causing the cell to rapidly discharge, further contributing to unsafe increases in cell temperature. It is an important safety feature for the separators to maintain shape and original size and to avoid electrode contact at high temperatures.

Inorganic composite materials have also been used as separators. Such composite separators include an aluminum oxide, silica (or other ceramic) filler material and a polymer binder. The filler and binder are blended and extruded to form a composite sheet and any volatile components are removed by extraction or evaporation to form a porous body. Other examples blend the filler and binder to form a mixture that is applied to a substrate by various coating means, such as doctor blading, roll coating or screen, stencil printing or gravure. In many cases, the composite separator materials contain a very high content of inorganic filler. In some instances, the separators exhibit poor properties, such as mechanical properties.

### II. The Embodiments

In an exemplary embodiment, the invention provides flexible PAO films. Exemplary films of the invention can reach a Fracture Strain of about 1.2×10⁻². In various embodiments, the invention provides films having a radius of curvature of at least about 0.6 mm, e.g., at least about 0.7, at least about 0.8, at least about 0.9 or at least about 1 mm. The films can curve to this degree without fracturing.

An exemplary embodiment provides a flexible porous aluminum oxide film having a tensile strength of at least about 1.2×10⁻².

Exemplary films of the invention are synthesized using the double anodization technique (e.g., Example. 4.1). Exemplary films of the invention have a thickness of from about 15 μm to about 40 μm. An exemplary film has a thickness of about 25 μm.

Exemplary films of the invention are porous. The total pore volume is sufficient to provide the desired level of ionic conductivity. Exemplary films are from about 5% to about 20% porous. An exemplary film of the invention is about 10% porous. In various embodiments, the invention provides porous films that are less than about 10% porous. In various embodiments, the films of the invention are more than about 25% porous, and can be more than about 50% porous, or more than about 75% porous, and even up to about 90% porous in some instances.

The films of the invention can include mono- or multi-modal distribution of pore sizes of any useful range. The pores of the films can have any size. The nominal pore size is typically measured in angstroms (10⁻¹⁰ m, Å). In one example, the average diameter of the pores is between about 1 and about 5000 Å. In another example, the volume average diameter of the substrate pores is between about 10 and about 5000 Å, between about 10 and about 4000 Å, between about 10 and about 3000 Å, between about 10 and about 2000 Å, between about 10 and about 1000 Å, between about 10 and about 800 Å, between about 10 and about 600 Å, between about 10 and about 400 Å, between about 10 and about 200 Å, between about 10 and about 100 Å, between about 20 and about 200 Å, between about 20 and about 100 Å, between about 30 and about 200 Å, between about 30 and about 100 Å, between about 40 and about 200 Å, between about 40 and about 100 Å, between about 50 and about 200 Å, between about 50 and about 100 Å, between about 60 and about 200 Å, between about 60 and about 100 Å, between about 70 and about 200 Å, between about 70 and about 100 Å, between about 80 and about 200 Å, between about 100 and about 200 Å, between about 100 and about 300 Å, between about 100 and about 400 Å, between about 100 and about 500 Å, between about 200 and about 500 Å or between about 200 and about 600 Å. In an exemplary embodiment, the pores are about 400 Å in diameter.

The specific surface area of the film can be any useful dimension. In exemplary films, the specific surface of the film is from about 0.1 to about 2,000 m²/g. For example, the specific surface area of the film is from about 1 to about 1,000 m²/g, from about 1 to about 800 m²/g, from about 1 to about 600 m²/g, from about 1 to about 400 m²/g, from about 1 to about 200 m²/g or from about 1 to about 100 m²/g of oxide. In another example, the specific surface area of the film is from about 3 to about 1,000 m²/g, from about 3 to about 800 m²/g, from about 3 to about 600 m²/g, from about 3 to about 400 m²/g, from about 3 to about 200 m²/g or from about 3 to about 100 m²/g of oxide. In yet another example, the specific surface area of the substrate is from about 10 to about 1,000 m²/g, from about 10 to about 800 m²/g, from about 10 to about 600 m²/g, from about 10 to about 400 m²/g, from about 10 to about 200 m²/g or from about 10 to about 100 m²/g of oxide.

Pore size distribution can be obtained using mercury intrusion analysis as is known in the art. In various embodiments, the pore size distribution is determined using standard procedures with samples of the oxide with an AutoPore Mercury Porosimeter.

The invention also provides methods of making the flexible, porous aluminum oxide films of the invention. An exemplary method for removing the film from the substrate on which it is formed relies on applying a negative current to the substrate. In various embodiments, the negative current is a reversal of the current under which the film was formed, e.g., anodization. As a result, the aluminum electrode is changed from being the anode to the cathode. Removing the film from the substrate typically occurs in an aqueous milieu. In various embodiments, the aqueous milieu comprises an organic (e.g., oxalic acid) or inorganic acid. Surprisingly, the films removed from the substrate in an aqueous environment incorporating an organic acid are more flexible than analogous films removed from the substrate in the absence of the organic acid.

In various methods of the invention, the free-standing oxide film is essentially free of water absorbed during the film synthesis and/or removal from the substrate. In an exemplary embodiment, the film is annealed at an elevated temperature. Typically the film is maintained at an elevated temperature for a time sufficient to drive off essentially all adsorbed water from the film. An exemplary temperature is from about 300° C. to about 500° C. An exemplary temperature is about 400° C. In various embodiments, the film is maintained at an elevated temperature from between about 30 minutes and about 5 hours. In an exemplary embodiment, the film is maintained at an elevated temperature for about 2 hours.

In an exemplary embodiment, the invention provides a battery in which a film of the invention is incorporated as a separator. An exemplary battery of the invention is a Li-ion battery.

The following examples are offered to illustrate selected embodiments of the invention, and are not intended to limit the scope of the invention.

### EXAMPLES

### Example 1

### 1. Flexible Porous Aluminum Oxide

The inherent brittleness of ceramic materials, including porous aluminum oxide (PAO), is a source of concern for its utilization as a separator in a lithium-ion battery. During assembly of a battery, significant torsion of materials is common. These manipulations can easily cause the material to crack and break—rendering the film inoperable as a separator.

To address the issue of flexibility, additional investigations into the formation of PAO films were performed. This example focuses on the second half of the separator synthesis—the removal of the PAO film from the aluminum substrate. The purpose was to analyze the effect that the release of the oxide has on the mechanical properties of the final product. This example describes the standard release method of PAO, based on amalgamation, and a new release method of PAO, based on a reverse current application. The new release method was shown to have a significant impact on the macroscale mechanical properties of PAO, which improved the flexibility of the PAO film. The macroscale mechanical properties were based on the Fracture Strain of the films determined by bending measurements, with XRD analysis being utilized to explain the difference in mechanical properties of the two films.

### 1.1 Standard PAO Synthesis

In standard processes to make free-standing PAO films, the aluminum oxide layer needs to be removed cleanly and completely from the aluminum metal from which it was grown. These processes generally involve an amalgamation step that uses mercuric chloride. The aluminum, with PAO on top, is floated on the surface of a saturated mercury(II) chloride solution (Example. 4.1) (Bessone, J., Corrosion Science, 2006, 48:4243-4256). A complex series of steps occurs, where the chloride in solution etches the passivating layer, exposing aluminum metal to water and mercury(II) ions. The electrons from the aluminum either reduce hydrogen to hydrogen gas (Eq. 1) or a Hg²+ ion to metallic mercury (Eq. 2), as both the gas and metal are observed. The metallic mercury can then form an amalgam with the exposed aluminum metal (Eq. 3). The amalgamated aluminum is then reduced to metallic mercury as more aluminum hydroxide is generated (Eq. 4). The generated mercury then cycles through Eq. 3 and 4 until the aluminum metal supply is exhausted.

2Al+6H₂O→2Al(OH)₃+3H₂ (1)

2Al+3Hg²⁺+6H₂O→2Al(OH)₃+6H⁺+2Hg (2)

Hg+Al→Hg.Al (3)

2Hg.Al+6H₂O→2Al(OH)₃+2Hg+3H₂ (4)

Since this process contains mercury, several obvious safety hazards and expenses arise. As a result, other redox couples have been used to remove the aluminum, such as using a saturated copper chloride solution (Eq. 5):

2Al+3Cu²⁺→2Al³⁺+3Cu (5)

Since this reaction does not have a catalytic cycle, extended exposure times are needed (12 h soaks instead of 5 min) Unfortunately, prolonged exposure of this degree to the chloride in the solution can cause etching that attacks the aluminum oxide. This attack may weaken the PAO, making it under-perform as a potential separator in a lithium-ion battery. As a result, a new method was developed that could produce free-standing thin-films (approximately 25 μm) of porous aluminum oxide in a way that does not utilize heavy metals.

### 1.2 Flexible PAO Synthesis

The PAO films used in this new removal process were first synthesized using the double anodization technique (Example. 4.1). The thickness of the PAO was then measured to be 25 μm with 10% porosity and 40 nm pores. A free-standing oxide film was then obtained using a new methodology that involves the use of a reverse current, in which after anodization, the direction of applied current is reversed. As a result, the aluminum electrode is changed from being the anode to the cathode.

The reversal of current attracts the H⁺ in solution to the surface of the aluminum because the electrode is now negatively charged. The H⁺ is responsible for two observable events: 1) it forms hydrogen gas at the surface of the electrode between the aluminum metal and the PAO and 2) it dissolves the oxide passivating layer on the aluminum.

The forming gas on the surface was the main contributor for the separation of the oxide and metal. Upon initiation of the reaction, tiny bubbles of hydrogen gas were seen forming along the edge of the aluminum cathode. Within 10 seconds, a popping sound was heard—indicating that the oxide had snapped from the aluminum metal. This was accompanied by the observation of large bubbles forming between the clear oxide film and metal underneath.

When removing the electrode from the solution, rinsing and drying the surface reveals that the film is mostly separated from the metal. Observing from the side, showed a small gap between the membrane and the aluminum. However, attempts at removing the film from the substrate by pushing a razor blade between the oxide and the aluminum showed that there are several places in which the film is still pinned to the surface. Attempts at forcibly pressing a razor blade past these regions caused excessive stress on the films, resulting in cracking.

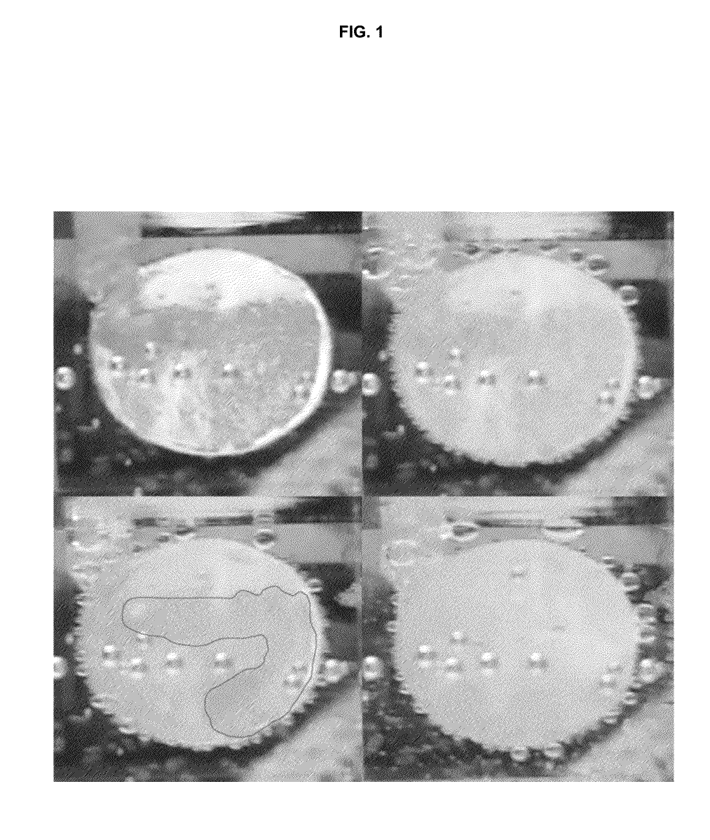

To completely remove the films from the surface, the second effect of the H⁺ was used. This step requires a longer amount of time than the previous step. The timescale is on the order of hours while the previous step was complete in minutes. The H⁺ in solution, ever being drawn to the surface of the electrode, aided in the dissolution of the aluminum oxide on the very surface of the electrode. The H⁺ dissolved the oxide on the aluminum exposing the metal to water, which then quickly re-passivated. This tandem of reactions continually occured and etched the surface non-uniformly. As a result, the process can be monitored by observing the appearance of the aluminum electrode. Initially the aluminum was very metallic and reflective. The PAO on the surface was clear and did not trap or scatter the light due to the small size of the pores and their regularity. When the H⁺ began to etch the surface beneath the PAO, the etching roughened the surface which then scattered light significantly. As a result, the surface slowly changed to a uniform white color that is non-reflective. At this stage, any areas of pinning were completely etched away, as the metal that caused the pinning was removed (FIG. 1).

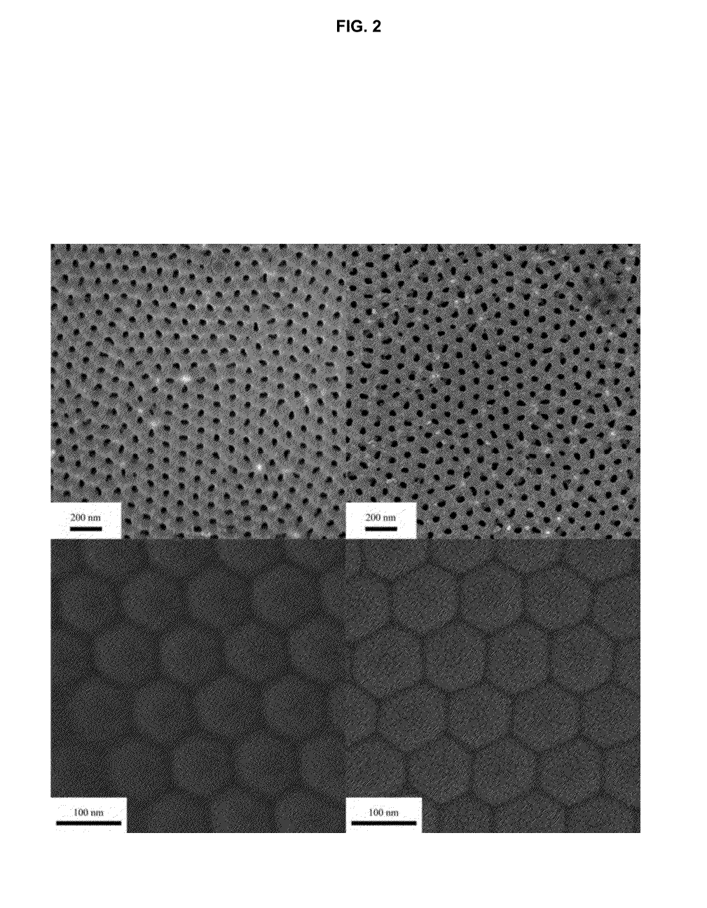

After a rinsing and drying period, the PAO had the same optical appearance as samples removed via amalgamation. Additionally, SEM imaging showed no discrepancies on either the open-pore side or closed-pore side of the PAO film (FIG. 2). This indicated that neither method has significant etching of the PAO that occurs during the removal process (as was the case when using saturated copper (II) chloride solutions). This is particularly important in the reverse current removal process, as the H⁺ etching of the pinning regions were thought to be a possible source of etching of the PAO film. However, the SEM images indicated that the enhanced H⁺ etching occurred only on the aluminum metal—the region of increased charge—and not on the porous oxide film.

### 1.3 Mechanical Properties of PAO Films

Though the two processes created seemingly identical films, via optical and SEM examination, the films actually had remarkably different mechanical properties. The film created by a reverse current was highly flexible compared to the film made by standard processing. The PAO released by a reverse current (flexible-PAO) was noted to withstand considerable bending over large areas of the film, while the PAO released by amalgamation (standard-PAO) could not.

The bendable properties of the PAO decrease the likelihood of failure in Li-ion battery assembly, as considerable stresses are present when putting together the cell. As a result, the mechanical properties of the two films were investigated more thoroughly and are covered in the sections below. The macroscale mechanical properties of the film were investigated by examining the Fracture Strain of the PAO films. The reasons for the difference in macroscale mechanical properties were examined via XRD analysis. The macroscale properties are important because those stresses would be common during cell assembly.

### 1.4 Macroscale Mechanical Properties of PAO

The Fracture Strain (£_{FS}) of standard-PAO and flexible-PAO, the limit to which the materials can be stretched before failure, was determined by video recording the bending of the films of the two types of PAO (these materials were synthesized, released, and measured as described in Example 3.1). The content below explains how these bending measurements yield the £_{FS}.

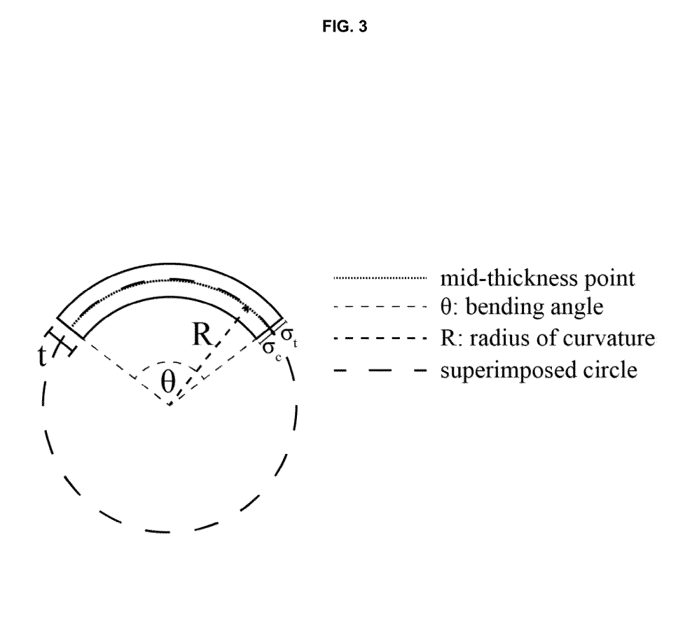

When a thin film is bent, there are two forms of stress present. There is tensile stress (the force that pulls the material apart) on the outer curve of the material, and compressive stress (the force that pushes the material together) on the inner curve (FIG. 3). When examining modes of failure of PAO while bending, only the tensile stress needs to be considered. In ceramic materials, the compressive strength exceeds the tensile strength, where the strength is defined as the greatest stress that the material can withstand before failing. Bulk aluminum oxide, for example, has a compressive strength an order of magnitude larger than its reported tensile strength (James F. Shackelford, W. A., CRC Materials Science and Engineering Handbook, 3rd edition; Ed.; CRC Press: 2000). This is expected due to the high charge that ceramic materials contain in their ions. This charge thus provides significant counter force when compression begins. Since less stress needs to be applied before a failure in the tensile case, this region will be examined

When the material is bent, defects effectively concentrate the stress field. However, since the greatest magnitude of stress is on the molecules on the very edge of the outer curve (because it is stretched to a larger degree), there are statically fewer regions of defects. As a result, bent materials report larger tensile strengths than materials stretched uniaxially. Thus, reported tensile strengths from bending are typically defined as moduli of rupture.

While the strength of a material is the greatest stress that can be applied before failure, the strain on a material is the ratio of the change in length to the original length—a percent change in length (Eq. 6).

$$ε = \frac{Δ L}{{L}_{0}} = \frac{{L}_{f} - {L}_{0}}{{L}_{0}} \qquad ( 6 )$$

The Fracture Strain (£_{FS}) can then be defined as the greatest change in length a material can be stretched before failure; this point occurs when the tensile strength (or modulus of rupture, when bending) is applied. To measure the Fracture Strain, a simple procedure was followed. A film of PAO was measured with a micrometer, and the thickness of the film was recorded. Then, using a video recording device with a high frame rate capture, the film was slowly bent between two fingers until the material failed under stress (fractured). The last frame of the video, before the film failed, was then analyzed. From this image, the radius of curvature and Fracture Strain was determined.

When a film is bent, the original length can be determined from the image by multiplying the radius of curvature (R) with the bending angle (θ); this yields the arc length (Eq. 7).

L₀=Rθ (7)

This correlation is true because the material that is above the mid-thickness point is considered to be under tensile strain (it is stretching), and the material that is below the mid-thickness point is under compressive strain. By definition, the mid-point is neither pulled apart nor pushed together; as a result, it has no change in length. To analyze the change in length of the outermost region of the material—that is, the region that contains the most strain—half the thickness (t) is added to the radius of curvature when calculating the arc length (Eq. 8).

$${L}_{f} = ( R + \frac{t}{2} ) θ \qquad ( 8 )$$

By combining Eq. 6, 7, and 8, we obtain the Fracture Strain (£_{FS}) of the system (Eq. 9). The math simplifies our needed measurements to calculate (£_{FS}) to the radius of curvature and the thickness of the film—thus, eliminating the need to measure the bending angle.

$${ε}_{FS} = \frac{( R + \frac{t}{2} ) θ - R θ}{R θ} = \frac{t}{2 R} \qquad ( 9 )$$

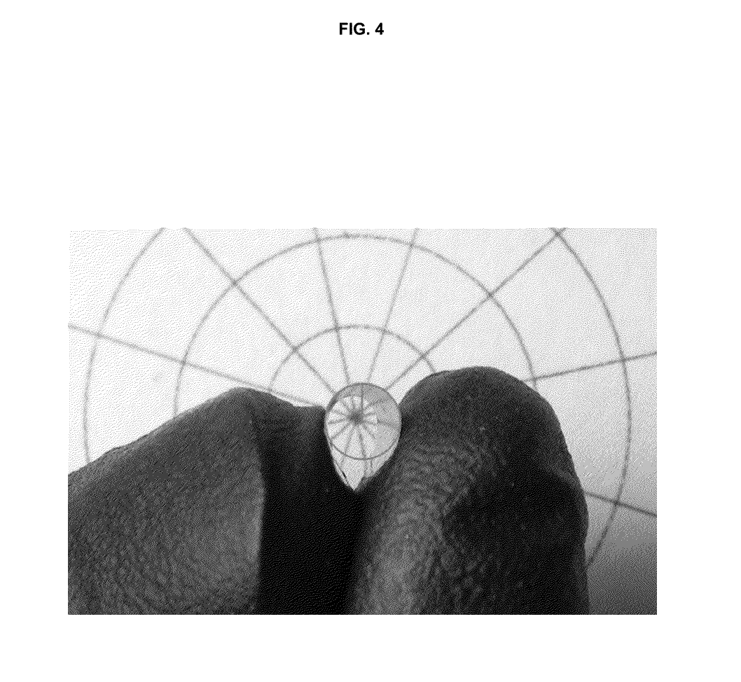

The radius of curvature is determined by image analysis of the last frame before failure. A circle is superimposed on the bending region of the film. The size and position of the circle is adjusted until the circle is overlain directly over the edge of the film. The radius of the circle that fits these criteria is the radius of curvature (FIG. 3). This process was completed on several flexible-PAO films as in FIG. 4. Using this process and Eq. 9, the flexible films can reach Fracture Strains between 1.254×10⁻² to 1.290×10⁻². These values are two orders of magnitude greater than the ultimate tensile strain of 80% dense aluminum oxide and one order of magnitude greater than standard-PAO: 5.059×10⁻⁴ to 6.5217×10⁻⁴ and 1.833×10⁻³; respectively (James F. Shackelford, W. A., CRC Materials Science and Engineering Handbook, 3rd edition; Ed.; CRC Press: 2000). These values show that not only is flexible-PAO capable of handling more strain than 80% dense aluminum oxide and standard-PAO, but it demonstrates that the porous nature is a large contributor to the observed flexibility.

When analyzing the strain present in a sample of standard-PAO, it should be noted that when a larger sample was used, a larger radius of curvature was measured (and, thus smaller the Fracture Strain). Originally, a large 18 mm diameter piece of standard-PAO was used. After a strain test was completed—shattering the PAO—a smaller fragment was collected and tested in the same way. Doing this series of data collection, the £_{FS} of the sample increased threefold from 1.833×10⁻³ to 5.50×10⁻³. This is easily attributed to the presence of fewer defects in the smaller sample. The large sample was broken along a defect—a scratch, crack, etc. As a result, the smaller sample did not have these defects present and was able to approach a £_{FS} that was closer to the true value of the material. In contrast, the bending properties of the flexible-PAO did not behave in this manner. The £_{FS} measurements of subsequently smaller samples of flexible-PAO resulted in values within 10% of each other. This suggests two important concepts: 1) the flexible-PAO is free of defects on a larger scale than standard-PAO, and 2) the flexible mechanical properties of PAO (whether flexible-PAO or standard-PAO) may be the natural state of PAO. As the pores may be able to alter in a way that disperses the stress field, akin to how chainmail can distribute force over a large area.

Using the measured £_{FS} of flexible-PAO, the pores could be expanding to as much as 1.29% and compressing the same amount on the other side of the film. As these films have 40 nm diameter pores, this correlates to an expansion and compression of 0.5 nm. It is clear that on the macroscale, the film appears to be bending significantly. However, on the nanoscale, the pores are barely altered. This revelation leads credence to the assumption that the pores accommodate for this flexibility.

TABLE 1
Data summary table of the radius of curvature (R) and Fracture
Strain (£_{FS}) of standard-PAO and flexible-PAO. The £_{FS}
of bulk 80% dense aluminum oxide from the CRC Materials Science
and Engineering Handbook is also provided as a comparison.

| Sample | R mm | £_{FS} unitless |
|---|---|---|
| Standard-PAO | 2.27-6.82 | 1.83 × 10⁻³-5.50 × 10⁻³ |
| Flexible-PAO | 0.969-0.997 | 1.25 × 10⁻²-1.29 × 10⁻² |
| 80% dense aluminum oxide | — | 5.059 × 10⁻⁴-6.522 × 10⁻⁴ |

### 2. Porous Aluminum Oxide Separators for Lithium Ion Batteries

The previous example focused on the development of a flexible separator material based on porous aluminum oxide. This new separator was developed to address several concerns with industrial-standard polypropylene separators, namely: their low mechanical strength that leads to dendritic shorts (Rosso, et al., Electrochimica Acta 2006, 51:5334-5340) and their chemical reactivity at elevated temperatures (Mikolajczak, et al., Lithium-Ion Batteries Hazard and Use Assessment; tech. rep.; Exponents Failure Analysis Associates, Inc., 2011). Using a ceramic material, such as PAO, in place of a polymer separator thus gives improvement in both these categories. As mentioned in earlier sections, the strength of PAO was found to be 5 to 6 times higher than that of polypropylene separators, and the thermal stability is 14 times higher. These characteristics combined with PAO being porous, wettable by ethylene and diethylene carbonate, ionically conductive, and non-electrically conductive make it an ideal candidate for a lithium-ion battery separator. This example focuses on the integration of the flexible-PAO, developed in the previous examples, into lithium-ion coin cells. Lithium-ion coin cells made with flexible-PAO separators are shown to cycle on par with industrial standard coin cells made with polypropylene separators. The cycling capability is demonstrated by measuring the initial specific capacity and coulombic efficiency of lithium-ion coin cells.

### 2.1 Fine-Tuning of PAO Separators

The PAO synthesized in this study was chosen to mimic commercially standard poly-propylene (PP) separators (Celgard 2500). The PP separators are 55% porous, as reported by the manufacturer, and previous literature reports the tortuosity to be 3.6 (Patel, et al., Journal of Power Sources, 2003, 122:144-152). The tortuosity is defined by Eq. 10:

$$τ = \frac{L}{C} \qquad ( 10 )$$

where τ is the tortuosity, L is the length of the pore, and C is the distance between the ends of the pore (the thickness of the material).

This large value indicates that the average pore within a PP separator has many twists and turns and the total length of the pore is 3.6 times the thickness of the material.

Both the porosity and the tortuosity are commonly used to report the Mac-Mullin number (Eq. 11) (Martnez, et al., Journal of The Electrochemical Society, 2009, 156:B80-B85):

$${N}_{M} = \frac{τ}{ɛ} \qquad ( 11 )$$

where N_{M} is the MacMullin number and ε is porosity of the material. This number allows one to easily compare the transport capabilities of different materials that have different values for both τ and ε, as the MacMullin number is directly related to the ionic transport capabilities of the material, assuming that the material does not interact chemically with the transporting ion (Martnez, et al., Journal of The Electrochemical Society, 2009, 156:B80-B85; Arora, et al., Chem. Rev., 2004, 104:4419-4462). By using Eq. 11, the MacMullin number of a PP separator is found to be 8.6.

To match the transport capabilities of the PP, the PAO is manufactured to have a similar MacMullin number. PAO forms straight uniform channels, as reported in the previous sections; as a result, the length of the pore is equal to the thickness of the PAO film and the tortuosity is unity. Though the porosity is 10%, the pores are slightly widened due to an etching procedure. On initial formation of the PAO, the pore bottoms are capped (FIG. 1). To ensure that the Li⁺ ions can migrate from one electrode to the other, the pore bottoms are etched open using a 10% w/w solution of phosphoric acid. The acid etches away at the alumina indiscriminately. As a result, the pore bottoms are etched open, but the pore walls are also etched wider. The film was immersed in the phosphoric acid for 30 min, which opened the bottom of the pores completely, and the walls were widened to a porosity of 12%, as determined by SEM analysis. Using the determined porosity and tortuosity of the PAO, the MacMullin number is calculated to be 8.3. As a result, the resistances caused by each separator (PP and PAO) are similar, and the cycling differences will be dependent only on the chemical and mechanical properties of the materials.

### 2.2 Determination of Cycling Capability

2.2.1 Experimental Methods and Control

Four generations of PAO separators were examined in this study. Each subsequent generation sought to improve the previous by identifying a potential area of optimization and correcting for it.

The PAO separators were manufactured via the two-step anodization method, as described in detail in Example 3.2. The anodization was performed for 9 h to achieve a thickness similar to Celgard 2500 (25 μm). The films were removed using the reverse current procedure detailed in Example 1.2. The variable removal conditions are outlined below, as the parameters were changed depending on the sample set.

The first generation films were made via the procedure listed above and removed with a reverse current procedure: 0° C., 0.20 M oxalic acid solution, 0.1 A cathodic current for 12 h. The resulting film displayed markedly improved mechanical flexibility over amalgamated aluminum oxide; however, the £_{FS} was lower than the fully optimized flexible-PAO mentioned in Example 1.2 (1.1242×10⁻² vs. 6.2232×10⁻³).

A second generation of films was produced to increase the flexibility of the PAO, which would make breaking during assembly less likely. The second generation films were improved upon from the first, by removing the films in a 20° C., 0.20 M oxalic acid solution, with a 0.1 A cathodic current for 4 h, as opposed to 0° C. bath.

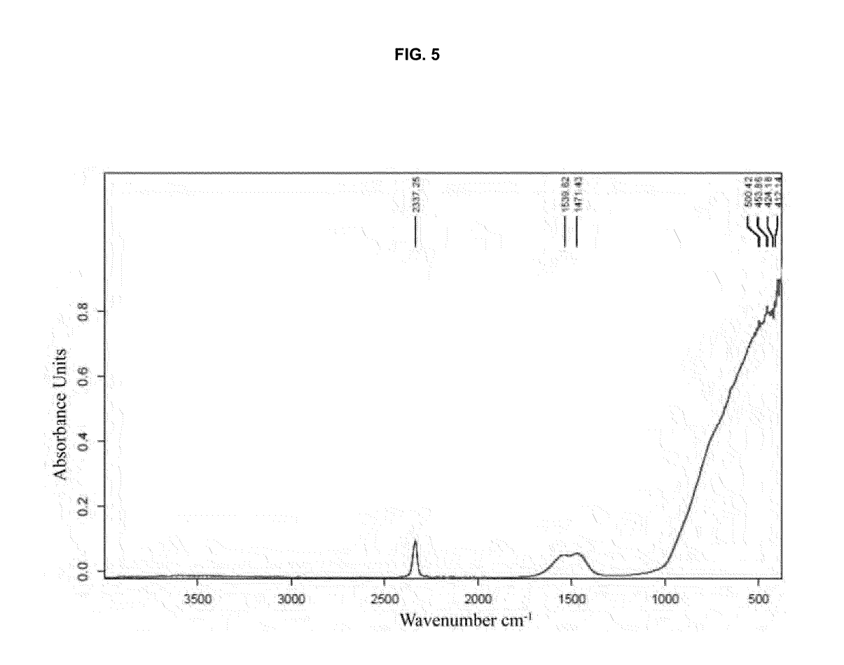

A third generation of PAO separator was designed to remove water sources, since lithium reacts vigorously with water and is quickly solubilized (Richens, et al., The Chemistry of Aqua Ions; Wiley: 1997; Haynes, W. M., CRC Handbook of Chemistry and Physics; Ed.; CRC Press: 2013-2014; Vol. 94). The third generation films were created by subjecting the second generation films to an annealing step of 400° C. for 2 hours, whereby the water in the aluminum oxide films was driven off (Mata-Zamora, et al., Revista Mexicana de Fisica, 2009, 51:502-509). The water was confirmed to be absent by examining the films with a Bruker Alpha FTIR spectrometer and noting the absence of a 3506 cm—vibrational mode (FIG. 5).

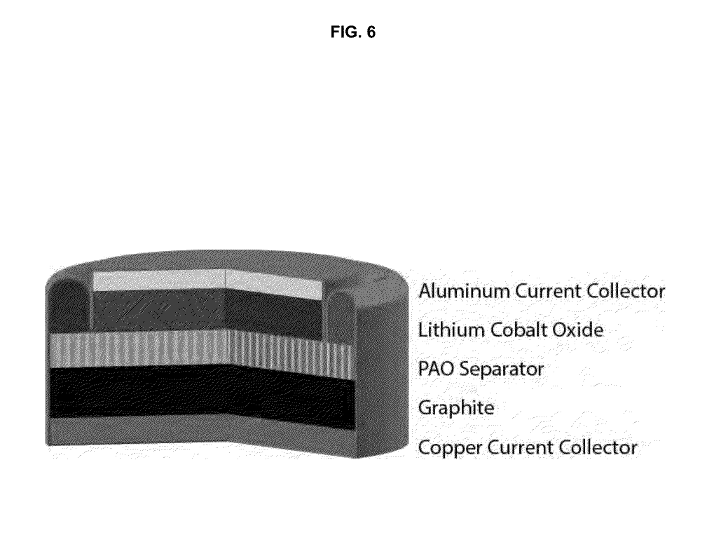

The separators were tested by using CR2032 cell configurations with an electrode area of 1.27 cm². A synthetic graphite electrode (Fullymax Inc.) coated on a copper current collector was placed in the bottom of the can. A separator (either synthesized Flex-PAO or Celgard) was stacked on top and 1 M LiPF₆ in EC:DEC (1:2 v/v) electrolyte was added onto the separator dropwise. An electrode of high power LCO (lithium cobalt oxide: Fullymax Inc.), coated on an aluminum current collector, was then placed on top of the separator. The top fitting of the coin cell was then placed and pressed to complete the cell (FIG. 6).

Configured samples were cycled using an Arbin BT2043 test station. Each Li-ion coin cell with PAO separator was cycled at C/4 (4 h to charge, 4 h to discharge) with a 3.93×10⁻² mA cm⁻² current density along with a coin cell with a PP separator as a control group. To prevent overcharging, 4.2 V was chosen as the maximum charge state of the battery. When this voltage was reached, the battery was switched to discharging. Similarly, the minimum voltage was chosen to be 3.0 V to prevent over discharging. The batteries were cycled until they reached 80% efficiency; at which point, they were considered spent and the cycling process was terminated. The initial cell capacity was determined by examining the capacity of each run and selecting the maximum from each data set. This maximum capacity was found several cycles from the first cycle and is present after the solid electrode interface (SEI) is established and stable. The coulombic efficiency (77 c) was then calculated from Eq. 12 from this starting position:

η_{c}=C_{f}^{1/n} (12)

where C_{f} is the final capacity as a percentage of the initial capacity and n is the number of cycles after the formation of the SEI layer. The coulombic efficiency is the percentage of how many coulombs a battery discharges by how many coulombs were used to charge it. The amount of charge released by the cell is always less than how much was put into it, due to the presence of side reactions. As a result, the cell capacity fades with each cycle.

### 2.2.2 Cycling Capabilities of Three Generations of PAO Separators

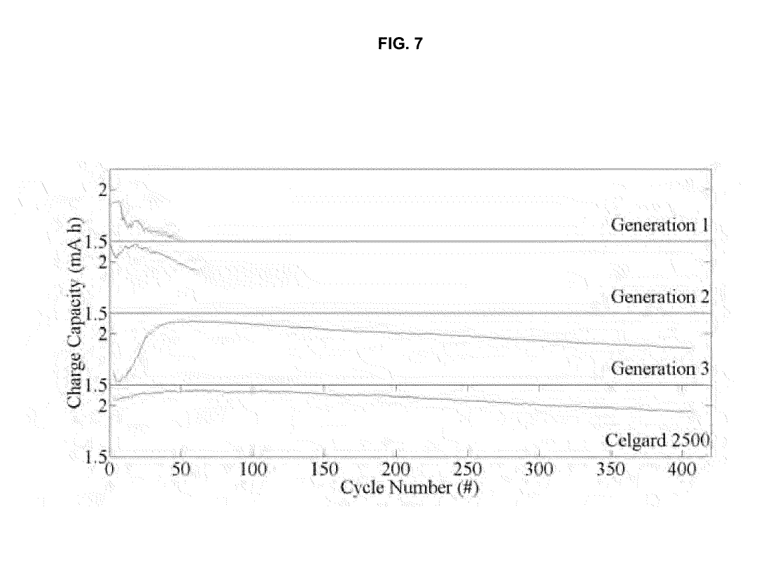

The three generations of PAO separators were assembled into CR2032 coin cell configurations and tested against control cells containing a Celgard 2500 separator. The results of all tested films are summarized in FIG. 7 and Table 2 and can be found at the end of this section.

Control cells had coulombic efficiencies of 99.97%, meaning that the cell would reach the dead state in 744 cycles, and an initial capacity of 2.522 mA h.

The first generation cells had a measured coulombic efficiency of 99.02%, meaning that the cell reached the failure point in less than 50 cycles. After terminating the cycling and leaving the coin cell electrically disconnected for two days, the voltage of the battery was measured with a multimeter, which indicated a voltage of 0 V. This quick rate of self-discharge is indicative of a soft-short within the battery. Further assembly of these cells yielded similar coulombic efficiency. However, some of the cells registered 0 V before cycling even began. As a result, it was determined that the shorts were caused by the assembly procedure, which caused cracking of the aluminum oxide.

The second generation cells, which were more flexible than the first generation, displayed improvement on the performance of the battery. None of these cells had potentials of 0 V after a 3 d post-assembly waiting period, indicating that the separators had remained intact during the cell assembly due to the enhanced flexibility of the films. The cells also showed a much greater initial cell capacity than the first generation; however, the coulombic efficiency was on average 99.34%. This average is well short of the 99.97% efficiency of Celgard separators. The second generation cells highlight the need to remove traces of water from the aluminum oxide, as the lithium-ions in the battery were likely reacting during the cycling procedure, which reduced the cycling efficiency.

Cycling measurements show that the third generation cells have a nearly identical coulombic efficiency to Celgard 2500 (99.96% versus 99.97%). This indicates that the degradation of the capacity is now only due to side reactions that are common in all lithium-ion batteries of this type, such as the formation of an SEI layer. The third generation of coin cell does have a slightly smaller initial cell capacity compared to Celgard 2500 cells (1.7% difference). This reduced capacity could be explained by deviations in the starting materials; however, it could also be due to a loss of lithium ions that are absorbing into the aluminum oxide structure, as this phenomenon has been noted previously in lithium-ion battery research (Jung, et al., Advanced Energy Materials, 2012, 2:1022-1027).

TABLE 2
Data summary of the coulombic efficiency (η), initial
capacity (mA h), final capacity as a percentage of the
initial, and the total number of cycles completed after
the SEI layer was established (the value in parenthesis)
for the 3 generations of PAO separators and Celgard 2500.

| | η_{c} | Cᵢ | C_{f} | Total |
|---|---|---|---|---|
| Gen. | (%) | (mA h) | (%) | Cycles |
| 1 | 99.02 | 1.7481 | 81.83 | 48(6) |
| 2 | 99.34 | 2.1771 | 87.64 | 63(18) |
| 3 | 99.96 | 2.1166 | 87.62 | 406(58) |
| Celgard 2500 | 99.97 | 2.1522 | 90.96 | 406(67) |

### 2.3 Conclusions

Porous aluminum oxide has been shown by this work to have the capability of performing as a separator in industry standard lithium-ion batteries. Exemplary films of the invention have improved macroscale flexibility of the PAO to prevent damage during assembly. Various films result from removing excess water content from the separator to prevent lithium/water side reactions. The first two generations of lithium-ion coin cells highlighted these key areas. The third generation PAO separators displayed a 99.96% coulombic efficiency and a 2.1166 mA h capacity—effectively matching the cells made with Celgard 2500 PP separators.

These initial steps indicate that PAO is an acceptable replacement for current separator technologies, with promise to increase the safety of batteries. The increased protections come from the exceptional hardness and strength of the material over PP. These properties should give PAO greater resistance to dendrite penetration and resistance from deformation from cell assembly. The introduction of PAO also reduces the overall chemical energy of cell, minimizing the combustibility of the battery. Experiments and procedures are being developed currently to test these qualities.

### 2.4 Isolating the Graphite Electrode

PAO separators in their capped form can be used to isolate the anode of a lithium-ion battery from the electrolyte. One of the disadvantages of the graphite anode and the lithium metal anode is the development of a solid-electrolyte interface layer because the surface of these anodes are quick to react with the electrolyte and develop a passivating layer that increases the impedance of the cell (Peled, E., Journal of The Electrochemical Society, 1979, 126:2047-2051; Shu, et al., Journal of The Electrochemical Society, 1993, 140:922-927; Aurbach, et al., Journal of The Electrochemical Society, 1994, 141:603-611). This formation is the primary reason of cell capacity fade. As a result, new technologies of anodes have been developed based on the spinel, lithium titanate (LTO) (Ohzuku, et al., Journal of The Electrochemical Society, 1995, 142:1431-1435; Colbow, et al., Journal of Power Sources, 1989, 26, 4th International Meetings on Lithium Batteries, 397-402; Jiang, et al., Electrochimica Acta, 2007, 52:6470-6475; Belharouak, et al., Journal of The Electrochemical Society 2007, 154:A1083-A1087; Ronci, et al., The Journal of Physical Chemistry B, 2002, 106:3082-3086; Cheng, et al., J. Mater. Chem., 2010, 20:595-602). This anode does not react adversely with the electrolyte; as a result, no SEI layer is formed, which allows for high charge and discharge rates and lower cell impedance. Batteries made with this anode are known to have over 99.995% coulombic efficiency, meaning that almost 5000 cycles could be achieved before being classified as “dead” by this study (Cheng, et al., J. Mater. Chem., 2010, 20:595-602). However, batteries made with this anode have 25% less energy density due to the bulk of the anode. This leads to heavier and bulkier batteries, an undesirable characteristic for EVs and mobile energy needs. Additionally, the use of LTO anodes drops the cell voltage from 4.2 V to 2.25 V. As a result, double the cells are needed to power any device that uses graphite as an anode in a Li-ion battery.

If it were possible to segregate the anode (graphite or Li-metal) from the electrolyte, it could then be possible to avoid the creation of an SEI layer that develops over time, which ultimately leads to the death of the battery. Current research based on synthetic SEI layer synthesis has shown promise on increased cycle efficiency (Jung, et al., Advanced Energy Materials, 2012, 2:1022-1027; Jung, et al., Journal of The Electrochemical Society, 2010, 157:A75-A81; Jung, et al., Advanced Materials, 2010, 22:2172-2176). The work relies on atomic layer depositions of aluminum oxide onto anodes. The thin layers of alumina have been shown to be ionically conductive to lithium and facilitate their transport.

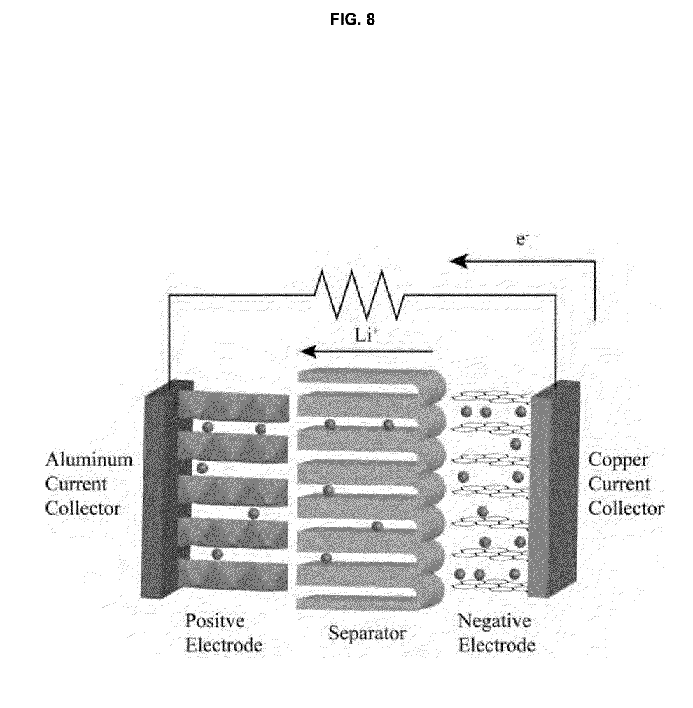

As noted previously, PAO forms initially with a capping layer with a thickness on the order of the voltage applied during anodization. A capped film of PAO could be used as a separator, as in FIG. 8, with the capped side of the PAO against the graphite. This configuration would isolate the negative electrode from the electrolyte, while allowing the electrolyte to be in contact with the positive electrode and within the pores of the separator. Thus, the electrolyte could still transport lithium from the positive electrode, through the separator, and then the lithium could transport through the thin capped layer of alumina to the negative electrode.

To accomplish this configuration, special attention needs to be given to the design of a new cell. In any coin cell, the electrolyte can penetrate not only through the porous separator but around the edges of it as well. A new design will have to be achieved in order to prevent the latter from occurring.

### 3. Methods

### 3.1 Flexible Porous Aluminum Oxide

### 3.1.1 Anodization Methods

All PAO films in this study were anodized using a double anodization technique with four steps: polishing, 1st anodization, chromic acid etch; 2nd anodization.

Polishing: An 18 mm diameter aluminum foil film (0.13 mm thickness, 99.9995%, Alfa Aeser) was polished to a mirror finish using a two-step mechanical polishing procedure was done by first polishing with diamond paste (1 μm MetaDi I I, Buehler) on a Buehler Ecomet IV polishing wheel. Then the rod was polished with a suspended silica solution (0.05 μm Non-Crystallizing Colloidal Silica, Allied High Tech Products, Inc.) These steps produced a smooth aluminum surface with a mirror shine. This created a very flat surface with an average defect size of 0.05 μm. The samples were then mounted on a glass slide with a mounting adhesive (Crystalbond 509, SPI supplies).

1st anodization: Each polished sample was placed in a 0° C. anodizing solution (0.2 M oxalic acid) and connected to the positive terminal of an Agilent E3641A power supply versus a platinum counter electrode. The solution was kept to temperature by placing it in an ice/water bath. A voltage of 40 V was applied for 4 h. The power supply was then switched off and the sample was removed and rinsed with D.I. water.

Chromic acid etch: Each sample was then immersed in a chromic acid solution (0.45 M chromium trioxide/2 vol. % phosphoric acid solution, at 60° C.) for 12 m. Each sample was rinsed heavily with D.I. water leaving behind a highly reflective surface with no cloudiness.

2nd anodization: Each etched sample was placed in a 0° C. anodizing solution (0.2 M oxalic acid) and connected to the positive terminal of an Agilent E3641A power supply versus a platinum counter electrode. The solution was kept to temperature by placing it in an ice/water bath. The anodization solution was the same solution used in the 1st anodization (0.2 M oxalic acid). A voltage of 40 V was applied for 9 h. The power supply was then switched off and the sample was removed and rinsed with D.I. water.

### 3.1.2 PAO Removal Methods

Films removed via reverse current (flexible PAO) were synthesized by immersing an anodized PAO film in a 0.3 M oxalic solution at 22° C. versus a platinum electrode. The aluminum/PAO electrode was attached to the negative terminal of an Agilent E3641A power supply, while the platinum was connected to the positive terminal. A constant current of 0.100 A was applied to the system for 1-4 h. The sample was removed from the solution and rinsed liberally with D.I. water. A pool of water was allowed to sit on the surface of the film as it lay flat on the bench-top. A razor blade was then used to cut the final connection between the PAO disk and the aluminum electrode tail. The sample was then rinsed again and air dried.

Films removed via amalgamation (standard PAO) were made by releasing anodized PAO from the glass slide with acetone and sonication. After acetone rinsing, the sample was placed aluminum metal side down into a saturated mercuric chloride solution (Alfa Aeser, 99.5+%). The film was removed and rinsed liberally with D.I. water after all metallic substances fell from the PAO film, and only a clear disk remained.

### 3.1.3 Characterization Methods

Fracture Strain measurements were made by measuring the thickness of free-standing PAO films (i.e. PAO removed from aluminum metal), via micrometer, and bending the films while filming with a video recording device. The last frame before the film snapped was taken as the maximum strain on the PAO. The radius of curvature of the film was then measured by superimposing a circle onto the image of the outer curve of the bent PAO film via image manipulating software (Adobe® Photoshop® CS5.5). The radius of that circle was taken as the radius of curvature. The Fracture Strain was then calculated via Eq. 9.

### 3.2 Porous Aluminum Oxide Separators for Lithium Ion Batteries

### 3.2.1 PAO Separator Synthesis and Coin Cell Assembly

PAO separators were created with the same anodization procedures and reverse current removal techniques as detailed in Example 3.1. Differences in processing of the separators are classed by generation. The first generation deviates from the parameters above by having the reverse current removal solution held at 0° C. instead of room temperature. The second generation had the reverse current removal solution held at 22° C. The third generation film had the same removal parameters as the second, but was subject to annealing. The sample was placed in a 400° C. for 4 h and was then quickly placed in a glove box with an argon atmosphere.

Each type of separator was assembled in a CR2032 coin cell, with an electrode area of 1.27 cm². A synthetic graphite electrode (Fullymax Inc.), coated on a copper current collector, was placed in the bottom of the can. A separator (either synthesized Flex-PAO or Celgard 2500) was stacked on top and 1 M LiPF6 in ethylene carbonate:diethylene carbonate (1:2 v/v) was added onto the separator dropwise. An electrode of high power LCO (lithium cobalt oxide: Fullymax Inc.), coated on an aluminum current collector, was then placed on top of the separator. The top fitting of the coin cell was then placed and pressed to complete the cell (FIG. 6).

### 3.2.2 Cell Cycling Methods

Each cell was cycled at C/4 (4 h charge, 4 discharge) with a 3.93×10⁻² mA cm⁻² current density using an Arbin BT2043 test station. The cells were charged to 4.2 V and discharged to 2.8 V. The cells were cycled until they reached 80% of maximum capacity after SEI formation. The software measured the voltage of the battery, current applied, and duration of charging/discharging. From this, the charge capacity and coulombic efficiency was calculated for each generation of coin cell and Celgard 2500 control (Eq. 12).

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A flexible porous aluminum oxide film having a tensile strength of at least about 1.2×10⁻².

2. The flexible porous aluminum oxide film of claim 1 having flexibility sufficient to allow it to flex through a radius of curvature of at least about 0.6 mm.

3. The film according to claim 1 having a thickness of from about 15 μm to about 40 μm.

4. The film according to claim 1 having a thickness of about 25 μm.

5. The film according to claim 1 having from about 5% to about 20% porosity.

6. The film according to claim 1 having about 10% porosity.

7. The film according to claim 1, wherein the pores have a diameter distribution selected from mono-modal and multi-modal.

8. The film of claim 1, wherein the pores are of a diameter from about 10 to about 600 Å.

9. The film of claim 1, wherein the pores are about 400 Å in diameter.

10. The film of claim 1, said film produced by a method comprising:
(a) removing said film from a substrate on which said film is formed by negatively charging said substrate in an aqueous milieu, attracting H+ ions to an interface between said film and substrate, thereby removing said film from said substrate.

11. The film of claim 1, said film produced by a method comprising:
(a) removing said film from a substrate on which said film is formed by negatively charging said substrate in an aqueous milieu, attracting H+ ions to an interface between said film and substrate, thereby removing said film from said substrate, wherein H+ removes said film from said substrate by a process which is a member selected from (i) forming H₂ gas at said interface; (ii) dissolving an aluminum oxide passivating film between said film and said substrate; and (iii) a combination thereof.

12. The film of claim 1, said film produced by a method comprising:
(a) removing said film from a substrate on which said film is formed by negatively charging said substrate in an aqueous milieu, attracting H+ ions to an interface between said film and substrate, thereby removing said film from said substrate, wherein H+ removes said film from said substrate, said method further comprising, (b) prior to step (a), preparing said film by double anodization.

13. The film preceding claim 1, said film produced by a method comprising:
(a) removing said film from a substrate on which said film is formed by negatively charging said substrate in an aqueous milieu comprising an acid, attracting H+ ions to an interface between said film and substrate, thereby removing said film from said substrate, wherein H+ removes said film from said substrate.

14. The film of claim 1, said film produced by a method comprising:
(a) removing said film from a substrate on which said film is formed by negatively charging said substrate, attracting H+ ions to an interface between said film and substrate, thereby removing said film from said substrate, wherein H+ removes said film from said substrate, said method further comprising, (c) annealing said film following said removing at a temperature and for a time sufficient to remove essentially all adsorbed water from said film.

15. A battery comprising a film of claim 1 as a separator.

16. The battery of claim 13, wherein said battery is a lithium-ion battery.
